(19) United States
(12) Patent Application Publication
(10) Pub. No.: US 2023/0178717 A1
(43) Pub. Date: Jun. 8, 2023

(54) TRANSITION METAL MECHANICAL CLAMPING LAYER

(71) Applicant: Intel Corporation, Santa Clara, CA (US)

(72) Inventors: Khaled Ahmed, San Jose, CA (US); Naoki Matsumura, San Jose, CA (US)

(21) Appl. No.: 18/055,601

(22) Filed: Nov. 15, 2022

Related U.S. Application Data
(60) Provisional application No. 63/287,334, filed on Dec. 8, 2021.

(51) Int. Cl. H01M 4/36; H01M 10/052; H01M 10/42; H01M 4/38; H01M 4/62

(52) U.S. Cl. CPC H01M 4/366; H01M 10/052; H01M 10/425; H01M 4/386; H01M 4/62; H01M 2004/021

(57) ABSTRACT

Methods, apparatuses, and systems may provide for technology used in batteries including an anode particle layer. Such an anode particle layer includes a plurality of silicon particles covered with a coating layer, where the coating layer comprises one or more of a transition metal sulfide and a transition metal chalcogenide.

### CROSS-REFERENCE TO RELATED APPLICATIONS

The present application claims the benefit of priority to U.S. Provisional Patent Application No. 63/287,334 filed on Dec. 8, 2021.

### TECHNICAL FIELD

Embodiments generally relate to batteries. More particularly, embodiments relate to technology used in batteries including an anode particle layer.

### BACKGROUND

Graphite anode material in Lithium-Ion Batteries (LIBs), features reliable cyclability, good conductivity, and little volume change. However, graphite has a medium capacity of ˜372 mAh/g and this hinders LIBs from higher energy density.

Silicon as an anode material is very promising but poses the most challenging issues for practical applications. Si has an extremely high capacity of 3579 mAh/g at room temperature, ×10 times higher than a commercial graphite anode. In addition, Si is cost-effective and abundant on the Earth. Thus, it is one of the most attractive anode materials.

However, Si has been hindered from practical uses due to its huge volume change of ˜300% and low electrical conductivity of 10⁻³ S/cm. Furthermore, these downsides are prone to cause many more harmful effects on Si anodes, e.g., continuous formation of solid electrolyte interface (SEI), electrochemical pulverization of silicon, and even cell failure, which results in short battery longevity. Thus, it is not viable to apply pure Si as an anode in LIBs.

Three different approaches are typically utilized to control the pulverization of silicon particles upon lithiation and delithiation: (a) without any protective shell or mechanical clamping layer, (b) hollow silicon particle without a mechanical clamping layer, and (c) hollow silicon particle with a single mechanical clamping layer.

Mechanical clamping layer materials in existing implementations include Carbon, Graphene, Sulphur-Doped Graphene, Nitrogen-Doped Graphene, and Titanium Nitride.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustrative diagram of three different approaches to control the pulverization of silicon particles;

FIG. 2 is an illustrative diagram of an example encapsulation of silicon particles by a carbon shell;

FIG. 3 is an illustrative block diagram of an example encapsulation of a silicon particle by a transition metal mechanical clamping layer according to an embodiment;

FIG. 4 is an illustrative block diagram of an example battery including a transition metal mechanical clamping layer according to an embodiment;

FIG. 5 is an illustrative block diagram of an example method for producing a battery including a transition metal mechanical clamping layer according to an embodiment;

FIG. 6 is an illustrative block diagram of an example system according to an embodiment; and

FIG. 7 is an illustrative diagram of an example of a system having a small form factor according to an embodiment.

### DETAILED DESCRIPTION

As described above, existing materials are not able to solve the reliability problem with silicon-anode LIBs when utilized to act as a “mechanical clamping layer”. The materials tried did not have the right combination of (1) mechanical elasticity, (2) strong adhesion to silicon particles, (3) path to high volume manufacturing, (4) electronic conductivity, and (5) Li+ ion conductivity. Mechanical clamping layer materials in existing implementations include Carbon, Graphene, Sulphur-Doped Graphene, Nitrogen-Doped Graphene, and Titanium Nitride.

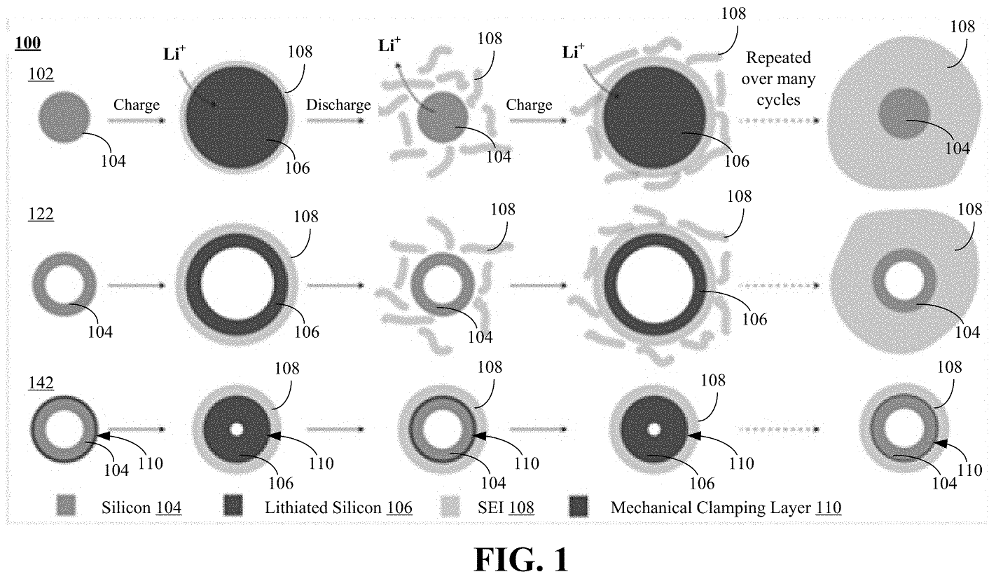

FIG. 1 is an illustrative diagram of three different approaches 100 to control the pulverization of silicon particles. As illustrated in FIG. 1, three different approaches 100 are shown to control the pulverization of silicon particles upon lithiation and delithiation: (a) approach 102 without any protective shell or mechanical clamping layer, (b) approach 122 hollow silicon particle without a mechanical clamping layer, and (c) approach 142 hollow silicon particle with a single mechanical clamping layer 110.

As illustrated in FIG. 1, three different approaches 100 include various configurations for charging silicon 104 into lithiated silicon 106 and discharging the lithiated silicon 106, which forms solid electrolyte interface (SEI) 108.

For example, a solid electrolyte interface (SEI) 108 is typically formed on the surface of the anode from the electrochemical reduction of the electrolyte. During the first charge and discharge of a lithium-ion battery, the electrode material reacts with the electrolyte at the solid-liquid phase interface. After the reaction, a thin film forms on the surface of the electrode material, where Li+ can be embedded and removed freely while electrons cannot. The SEI 108 is about 100-120 nm thick, and it is mainly composed of various inorganic components, such as Lithium Carbonate (Li2CO3), Lithium Fluorine (LiF), Lithium Oxide (Li2O), Lithium Hydroxide (LiOH), as well as some organic components like Lithium Alkyl Carbonates (ROCO2Li). The formation of the SEI 108 film has a crucial impact on the performance of electrode materials. On one hand, in the formation of the SEI 108 film, parts of the lithium ions are consumed, which increases the irreversible capacity of batteries and reduces the charge and discharge efficiency of the electrode material. On the other hand, the SEI 108 is insoluble in organic solvents and can exist in stable condition in organic electrolyte solutions. Furthermore, solvent molecules cannot pass through it, thus effectively preventing the co-embedding of the ions and avoiding damage to the electrode material. This greatly improves the cycling performance and service life of the battery.

When the carrier ions move between electrodes, one of the persistent challenges resides in the fact that the electrodes tend to expand and contract as the battery is repeatedly charged and discharged. The expansion and contraction during cycling tends to be problematic for reliability and cycle life of the battery because when the electrodes expand, electrical shorts and battery failures occur.

Graphene Shells

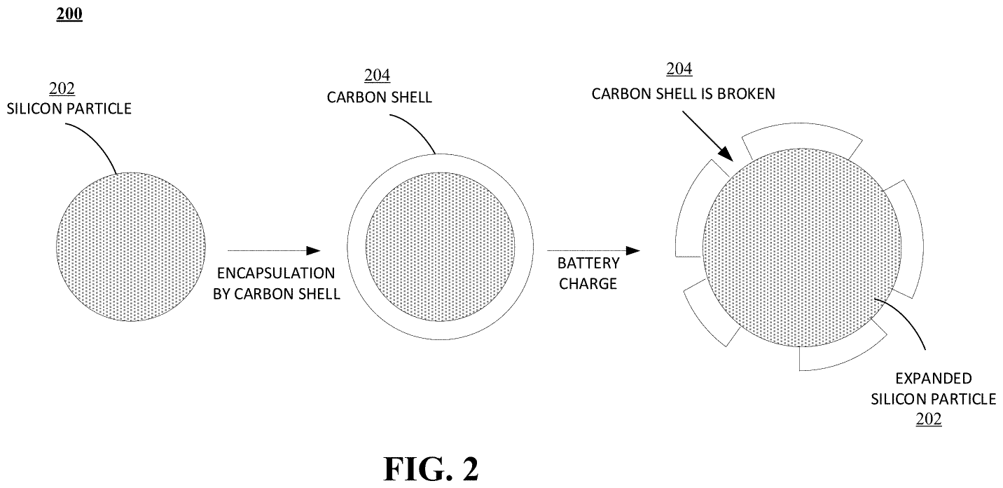

FIG. 2 is an illustrative diagram of an example encapsulation 200 of silicon particles 202 by a carbon shell 204. As illustrated in FIG. 2, one approach is to coat silicon particles 202 (e.g., nanoparticles) a with Graphene carbon shell 204. Graphene nanosheets (GNS) have an average d-spacing of ˜0.365 nm. Differing from the intercalation-based bulk-type graphite, a single layer graphene may have a different electrochemical mechanism. Enhanced battery capacity is associated with GNS in comparison to graphite, and this enhancement may be explained by the different electronic structure of GNS and that the expansion in the d-spacing of the graphene layers can cause additional sites to accommodate Li⁺ ions. A graphene overlayer could effectively prevent the electrolyte from reaching the silicon nanoparticles inside and therefore enabled the inhibition of excessive growth of the SEI layer on the Si surface under repeated volume change.

The simplest method for Si-graphene composites is via a mechanical mixing or solution-filtration process, in which Si particles are mixed with graphene in a certain ratio. The resultant Si-graphene composites exhibit noticeable improvements over the pure graphene and Si performance. However, these composites also demonstrate several shortcomings: (i) high surface area leading to large irreversible capacity loss; (ii) low CE; and (iii) questionable stability. The reason lies in the lack of a strong interaction between graphene and Si particles in these composites. In order to improve the interaction between the graphene and Si particles, graphene may be covalently bonded to Si nanoparticles. DFT simulations indicate that some Si atoms formed covalent interactions with sulfur atoms in Sulfur-doped Graphene (SG) and two adjacent carbon atoms. These Si atoms do not participate in alloy formation with lithium but provide anchoring sites for the majority of Si atoms within the Si nanoparticle that are readily available for alloying-dealloying. Indeed, Si bound more strongly to SG than on graphene (i.e., G), which is ascribed to the strong covalent interaction between the Si atoms with the sulfur atom. Silicon coated by Nitrogen-doped Graphene exhibits dramatically improved cycling stability and much higher sustainable capacity over silicon nanoparticles and graphene.

As will be described in greater detail below, systems, apparatuses and methods of some implementations herein provide for technology that forms reliable, high density LIBs using a material for making “mechanical clamping layers” that helps keep the silicon particles intact upon expansion/contraction due to charging/discharging cycles, in some examples.

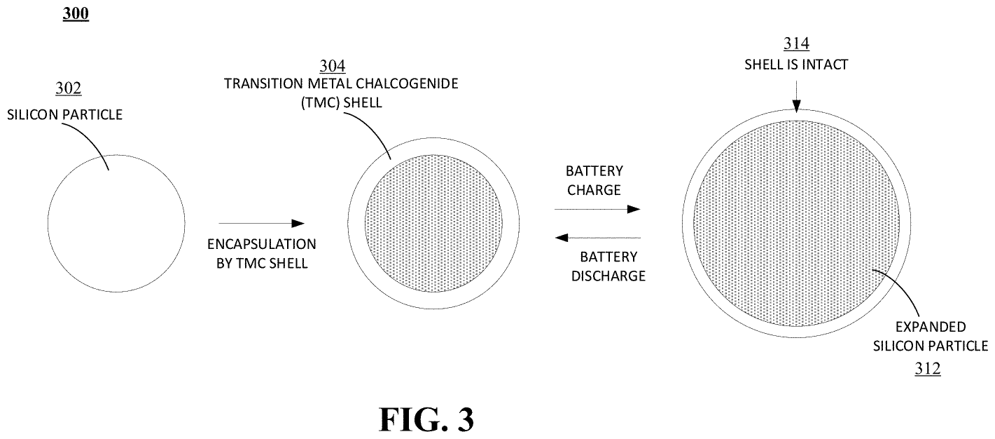

FIG. 3 is an illustrative block diagram of an encapsulation 300 of a silicon particle 302 by a transition metal mechanical clamping layer 304 according to an embodiment. As illustrated in FIG. 3, the techniques described herein are utilized produce an intact shell 314 after repeated battery charging and discharging cycles have produced an expanded silicon particle 312.

The illustrated encapsulation 300 advantageously provides for reliable, high density LIBs using a material for making “mechanical clamping layers” that helps keep the silicon particles intact upon expansion/contraction due to charging/discharging cycles.

For example, some of the implementations described herein utilize a mechanical clamping layer that is one of the material class called “transition metal sulfides”. These materials include TiS₂, TaS₂, MoS₂, WS₂, the like, and/or combinations thereof. Additionally, or alternatively, some of the implementations described herein utilize a mechanical clamping layer that is a transition metal chalcogenide (e.g., selenides, tellurides, the like, and/or combinations thereof).

Transition metal chalcogenides have the following advantages: (1) higher mechanical elasticity compared to existing carbon-based layer (e.g., MoS₂: 230 GPa, vs. existing graphite: 8-15 GPa) (2) active to Li+ to facilitate high mobility of Li+ ions to and from the silicon particle because of its layered structure, (3) high electronic conductivity (since these materials are semi-metals or metals) as good as existing carbon-based layer (e.g. TiS₂ and Graphite: ˜10⁴ S cm⁻¹, and (4) these materials can be conformally coated on the silicon particles with appropriate thickness of 1-3 nm using known manufacturing equipment and processes such as liquid-phase atomic layer deposition, thermal atomic layer deposition, radical plasmas, and others.

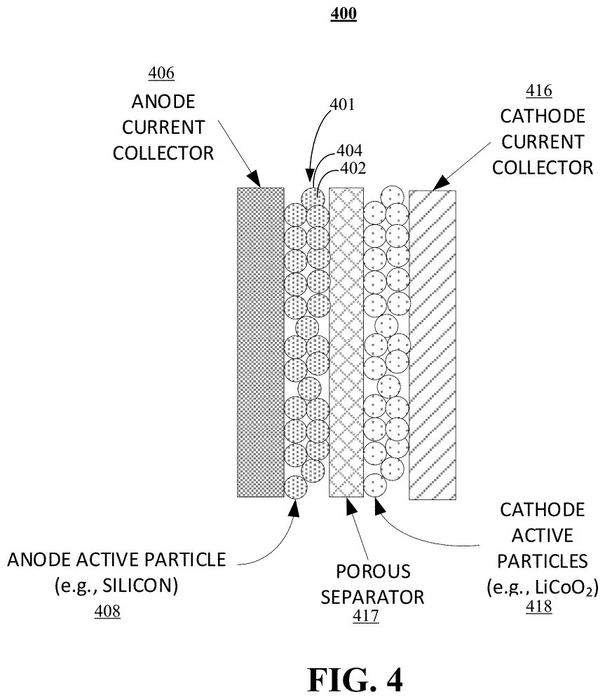

FIG. 4 is an illustrative block diagram of an example battery 400 including an encapsulation 401 of active material particles 402 by a coating shell 404 (e.g., as described in FIG. 3 above) according to an embodiment. As illustrated, battery 400 includes an electrode current collector 406 and an electrode compound layer 408 that coats the electrode current collector 406. The electrode compound layer 408 includes a plurality of active material particles 402 covered with a coating shell 404, where the coating shell 404 includes one or more transition metal chalcogenides.

In some examples, the one or more transition metal chalcogenides include one or more transition metal sulfides.

In some implementations, the one or more transition metal chalcogenides include a component that is MoS₂, TiS₂, TaS₂, WS₂, MoSe₂, WSe₂, the like, and/or combinations thereof.

In some examples, the coating shell 404 has one or more layers, where at least one layer of the one or more layers has a property that is a recoverable tensile strain no less than 10% when measured without an additive or without a reinforcement, a lithium ion conductivity no less than 10\hat{ }(−5) Siemens per centimeter at room temperature, a thickness from 0.5 nm to 100 μm, the like, and/or combinations thereof. In some implementations, the lithium ion conductivity may be between one Siemens per centimeter and 10\hat{ }(−6) Siemens per centimeter.

In some implementations, the coating shell 404 has a plurality of layers. In some examples, the plurality of layers includes a first layer and a second layer, where the first layer is interposed between the second layer and an individual particle of the plurality of active material particles, where the first layer is of a different material composition than the second layer, and where the first layer has a more sulfur-rich material composition as compared to the second layer.

In some examples, the plurality of active material particles 402 includes a material that is silicon, silicon oxide, lithium metal, lithium oxide, sulfur, sulfur oxide, tin, tin oxide, carbon, the like, and/or combinations thereof.

In some implementations, the plurality of active material particles 402 includes a particle that is a spherical nano particle, an ellipsoidal nano particle, an irregular shape nano particle, a nano wire, a nano fiber, a nano tube, a nano sheet, a nano belt, a nano ribbon, a nano disc, a nano platelet, a nano strip, a nano horn, the like, and/or combinations thereof having a thickness from 1 nanometers to 100 nanometers. Alternatively, in some implementations, the thickness may be between 10 nanometers and 60 nanometers.

In some examples, the plurality of active material particles includes a silicon-based material powder with an average particle size between 10 nanometers and 10,000 nanometers, or the like. Alternatively, in some implementations, the average particle size is between 10 nanometers and 2,000 nanometers or between 100 nanometers and 1,000 nanometers.

In some implementations, the electrode conductor 406 includes an anode current collector and where the electrode compound layer coats 408 the anode current collector. Additionally, or alternatively, the electrode conductor 406 includes a cathode current collector and where the electrode compound layer 408 coats the cathode current collector.

Additionally, or alternatively, a cathode current collector 416 may be positioned opposite an anode current collector (illustrated here as the electrode conductor 406) with a porous separator 417 positioned between the cathode current collector 416 and the anode current collector. In the illustrated example, an active particle layer 418 coats the cathode current collector 416. The active particle layer 418 may be composed of a different material as compared to the electrode compound layer 408. For example, the active particle layer 418 may include LiCoO₂ active material particles, the like, and/or combinations thereof.

In some examples, the battery 400 is a rechargeable lithium battery.

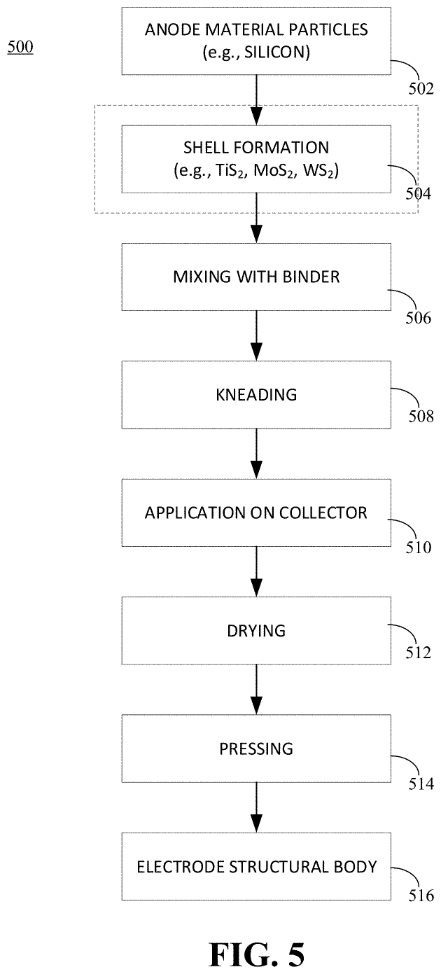

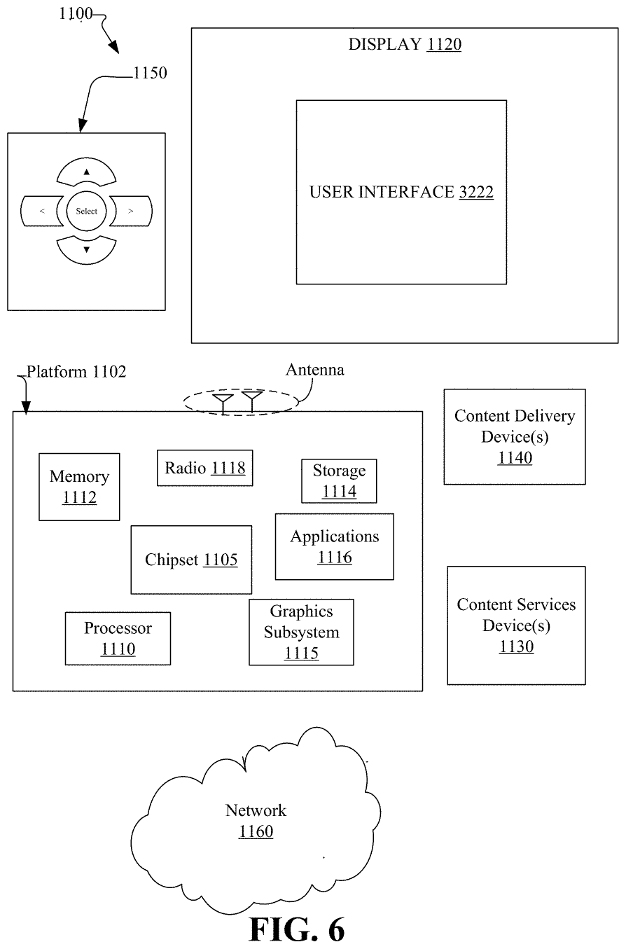

In some implementations, the battery 400 is included in a system having a processor coupled with the battery. For example, see the systems illustrated below in FIG. 5 and FIG. 6.

FIG. 5 is an illustrative block diagram of an example method for producing a battery including a transition metal mechanical clamping layer according to an embodiment. As illustrated in FIG. 5, a method is illustrated for making a battery with the techniques described herein, such as, for example, the battery 400 (e.g., see FIG. 4).

Illustrated processing block 502 provides for forming a plurality of active material particles. For example, silicon anode material particles may be formed as a plurality of active material particles.

Illustrated processing block 504 provides for covering the plurality of active material particles with a coating shell. In some implementations, the coating shell includes one or more transition metal chalcogenides.

For example, the one or more transition metal chalcogenides include a component that is MoS₂, TiS₂, TaS₂, WS₂, MoSe₂, WSe₂, the like, and/or combinations thereof.

Illustrated processing block 506 provides for mixing the shell coated active material particles with a binder, and kneading this compound (e.g., as an electrode compound layer) at processing block 508.

Illustrated processing block 510 provides for coating an electrode current collector with the electrode compound layer. For example, where the electrode compound layer includes the plurality of active material particles covered with the coating shell.

Illustrated processing block 512 provides for drying the coated electrode current collector.

Illustrated processing block 514 provides for pressing the dried coated electrode current collector.

Illustrated processing block 516 provides for assembling an electrode structural body from the electrode current collector (e.g., after pressing, drying, and/or coating).

Layered Transition Metal Chalcogenides Mechanical Clamping Layer

Layered metal chalcogenides (LMCs) and their intercalation compounds are discussed in greater detail below. Layered metal chalcogenides (LMCs) and their intercalation compounds have intriguing structural and physical properties of these two-dimensional (2D) inorganic materials. In the general case, these structures consist of infinite metal chalcogenide layers; within each layer the atoms are bound by strong covalent interactions, but the layers themselves interact only by weaker van der Waals forces. For the most part, the metals involved are transition metals. TMCs are an important family of 2D layered materials. A typical atomic ratio in layered TMCs is one transition metal (M) to two chalcogen (X) atoms to create MX₂ (e.g., MoS₂, TiS₂, TaS₂, WS₂, MoSe₂, and WSe₂). 2D TMCs have great potentials for a wide variety of applications such as energy storage.

Depending on the metal and the specific structure, LMCs may be semiconductors, semimetallic, or metallic.

MoS₂ is one example of a material among such TMCs. As lithium-ion battery anodes, MoS₂ suffers from low electrical and ionic conductivity. To this end, various MoS₂ composites may demonstrate improved performance, such as microspheres, nanotubes, and other nanostructured composites.

MoS₂ has a unique structure with an interlayer distance of ˜0.62 nm (much larger the 0.34 nm spacing of graphite), facilitating a fast diffusion of Li⁺ ions. This may make MoS₂ a useful anode material for LIBs. TEM data indicated that Li⁺ ions initially intercalate into the layered MoS₂ to form LixMoS₂ intercalates at the beginning of the lithiation. As the deep lithiation proceeds, a layer-by-layer conversion reaction occurs with the products of Mo and Li₂S.

In addition to MoS₂, WS₂ is another example of a material among such TMCs. WS₂ has a higher intrinsic electrical conductivity and is potentially promising as an anode material (e.g., WS₂ LIB anodes).

Besides MoS₂ and WS₂, there are also other TMCs that may be suitable electrode materials in LIBs, such as VS₂, NbSe₂, and MoSe₂.

LMCs such as TiS₂ and MoS₂ also may be utilized as cathodic materials in lithium-anode batteries.

Synthesis of TMCs

The physical, and sometimes chemical, properties of metal chalcogenides can be greatly influenced by the method of preparation and depend strongly on product purity and composition as well as on the structural and electronic effects that arise due to nonstoichiometry. Some main-group and transition metals will react with stoichiometric amounts of sulfur, selenium, and tellurium to form metal chalcogenides at elevated temperatures. Desired products may not be stable at the elevated temperatures required to activate the elemental solids to complete reactions. The vapor-phase method may be used to synthesize a number of transition metal dichalcogenide particles by reaction of a suitable metal chloride with hydrogen sulfide gas at elevated temperature. One example reaction proceeds as detailed below.

MX₄+2H₂S→MS₂+4HX

For example, TiS₂ particles may be prepared by reaction of TiCl₄ with H₂S at 450° C. The gas-phase reaction is represented by the equation below.

TiCl₄+2H₂S→TiS₂+4HCl

Low-temperature 100° C.) preparation routes may be utilized to prepare the various types of LMCs. For example, a solution method for preparing Group 4, 5, and 6 transition metal dichalcogenides may be utilized. A low-temperature metathesis occurs between a transition metal halide (MXₙ) and an alkali metal sulfide (A₂S) in an aprotic polar organic solvent such as tetrahydrofuran (THF) or ethyl acetate. For example, in THF at ambient temperature, the following reaction may be used to form TiS₂ at 65° C.

TiCl₄+2Li₂S→TiS₂+4LiCl

Other alkali metal ions such as Li⁺, Na⁺, or the ammonium ion NH₄⁺ may be utilized. The products of this reaction are mainly amorphous and may be converted into a crystalline product by thermal treatment at 400-600° C. in an evacuated tube or in Sulfur ambient.

Other TMCs such as HfS₂, MoS₂, NbS₂, TaS₂, VS₂, and ZrS₂ may be prepared using this method.

For thin film (e.g., 3-10 m) formation, low temperature processes such as PVD, CVD, and ALD may be utilized.

Advantages of TMCs as Shells for Silicon Particles Over Graphene

Sulfur makes a strong bond with Silicon.

TMCs have layered structures which can facilitate Li+ migration in and out of the Si particles.

The TMCs shell provides room for expansion of the anodically active material (silicon) upon the entry of carrier ions (Lithium).

Additionally, or alternatively, the techniques described herein are applicable to other anode materials such as Li metal, Sn, silicon oxide, the like, and/or combinations thereof

Other Advantages

Some of the implementations described herein advantageously provide reliable and high energy density (e.g., a long battery life with sufficient longevity) lithium-ion batteries for laptop and other mobile devices.

Some of the implementations described herein advantageously provide materials that are amenable to high volume manufacturing.

### Example Implementations

In one example, an anode material is covered or coated with at least one transition metal chalcogenide.

In another example, an electrode material for a rechargeable lithium battery includes a fine powder of a silicon-based material whose principal component is silicon element, said fine powder having an average particle size (R) in a range of 10 nm≤R≤10000 nm.

In still another example, an electrode structural body for a rechargeable lithium battery includes an electrode material layer including the silicon-based material fine powder described herein.

In yet another example, a rechargeable lithium battery includes an anode including an electrode structural body having an electrode material layer including the silicon-based material fine powder described herein.

In a further example, an anode material includes one or more of silicon, lithium metal, sulfur, tin, these oxides, carbon, the like, and/or combinations thereof.

In a still further example, an anode active material layer for a lithium battery, includes multiple particulates of an anode active material, where a particulate is composed of one or a plurality of particles or layers of a high-capacity anode active material being embraced or encapsulated by a thin layer of a high-elasticity transition metal chalcogenide (TiS₂, MoS₂, WS₂, etc.) having a recoverable tensile strain no less than 10% when measured without an additive or reinforcement, a lithium ion conductivity no less than 10⁻⁵ S/cm at room temperature, and a thickness from 0.5 nm (or a molecular monolayer) to 10 μm (preferably less than 100 nm).

In a yet further example, an anode active material is in a form of nano particle (spherical, ellipsoidal, and irregular shape), nano wire, nano fiber, nano tube, nano sheet, nano belt, nano ribbon, nano disc, nano platelet, nano strip, or nano horn having a thickness or diameter less than 100 nm. These shapes can be collectively referred to as “particles”.

Additionally, or alternatively, multiple shells can be utilized with different materials such as Si coated with the first layer (e.g., TiS₂) and the second layer (e.g., MoS₂). For example, an electrode material may be coated with the first sulfur-rich layer followed by less-sulfur layers.

FIG. 6 illustrates an embodiment of a system 1100. In embodiments, system 1100 may include a media system although system 1100 is not limited to this context. For example, system 1100 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, or smart television), mobile internet device (MID), messaging device, data communication device, and so forth.

In embodiments, the system 1100 includes a platform 1102 coupled to a display 1120 that presents visual content. The platform 1102 may receive video bitstream content from a content device such as content services device(s) 1130 or content delivery device(s) 1140 or other similar content sources. A navigation controller 1150 including one or more navigation features may be used to interact with, for example, platform 1102 and/or display 1120. Each of these components is described in more detail below.

In embodiments, the platform 1102 may include any combination of a chipset 1105, processor 1110, memory 1112, storage 1114, graphics subsystem 1115, applications 1116 and/or radio 1118 (e.g., network controller). The chipset 1105 may provide intercommunication among the processor 1110, memory 1112, storage 1114, graphics subsystem 1115, applications 1116 and/or radio 1118. For example, the chipset 1105 may include a storage adapter (not depicted) capable of providing intercommunication with the storage 1114.

The processor 1110 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 1110 may include dual-core processor(s), dual-core mobile processor(s), and so forth.

The memory 1112 may be implemented as a volatile memory device such as, but not limited to, a Random Access Memory (RAM), Dynamic Random Access Memory (DRAM), or Static RAM (SRAM).

The storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 1114 may include technology to increase the storage performance enhanced protection for valuable digital media when multiple hard drives are included, for example.

The graphics subsystem 1115 may perform processing of images such as still or video for display. The graphics subsystem 1115 may be a graphics processing unit (GPU) or a visual processing unit (VPU), for example. An analog or digital interface may be used to communicatively couple the graphics subsystem 1115 and display 1120. For example, the interface may be any of a High-Definition Multimedia Interface (HDMI), DisplayPort, wireless HDMI, and/or wireless HD compliant techniques. The graphics subsystem 1115 could be integrated into processor 1110 or chipset 1105. The graphics subsystem 1115 could be a stand-alone card communicatively coupled to the chipset 1105.

The radio 1118 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In embodiments, the display 1120 may include any television type monitor or display. The display 1120 may include, for example, a computer display screen, touch screen display, video monitor, television-like device, and/or a television. The display 1120 may be digital and/or analog. In embodiments, the display 1120 may be a holographic display. Also, the display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, the platform 1102 may display user interface 1122 on the display 1120.

In embodiments, content services device(s) 1130 may be hosted by any national, international and/or independent service and thus accessible to the platform 1102 via the Internet, for example. The content services device(s) 1130 may be coupled to the platform 1102 and/or to the display 1120. The platform 1102 and/or content services device(s) 1130 may be coupled to a network 1160 to communicate (e.g., send and/or receive) media information to and from network 1160. The content delivery device(s) 1140 also may be coupled to the platform 1102 and/or to the display 1120.

In embodiments, the content services device(s) 1130 may include a cable television box, personal computer, network, telephone, Internet enabled devices or appliance capable of delivering digital information and/or content, and any other similar device capable of unidirectionally or bidirectionally communicating content between content providers and platform 1102 and/display 1120, via network 1160 or directly. It will be appreciated that the content may be communicated unidirectionally and/or bidirectionally to and from any one of the components in system 1100 and a content provider via network 1160. Examples of content may include any media information including, for example, video, music, medical and gaming information, and so forth.

The content services device(s) 1130 receives content such as cable television programming including media information, digital information, and/or other content. Examples of content providers may include any cable or satellite television or radio or Internet content providers. The provided examples are not meant to limit embodiments.

In embodiments, the platform 1102 may receive control signals from a navigation controller 1150 having one or more navigation features. The navigation features of the controller 1150 may be used to interact with the user interface 1122, for example. In embodiments, the navigation controller 1150 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 1150 may be echoed on a display (e.g., display 1120) by movements of a pointer, cursor, focus ring, or other visual indicators displayed on the display. For example, under the control of software applications 1116, the navigation features located on the navigation controller 1150 may be mapped to virtual navigation features displayed on the user interface 1122, for example. In embodiments, the controller 1150 may not be a separate component but integrated into the platform 1102 and/or the display 1120. Embodiments, however, are not limited to the elements or in the context shown or described herein.

In embodiments, drivers (not shown) may include technology to enable users to instantly turn on and off the platform 1102 like a television with the touch of a button after initial boot-up, when enabled, for example. Program logic may allow the platform 1102 to stream content to media adaptors or other content services device(s) 1130 or content delivery device(s) 1140 when the platform is turned “off.” In addition, chipset 1105 may include hardware and/or software support for (5.1) surround sound audio and/or high definition (7.1) surround sound audio, for example. Drivers may include a graphics driver for integrated graphics platforms. In embodiments, the graphics driver may include a peripheral component interconnect (PCI) Express graphics card.

In various embodiments, any one or more of the components shown in the system 1100 may be integrated. For example, the platform 1102 and the content services device(s) 1130 may be integrated, or the platform 1102 and the content delivery device(s) 1140 may be integrated, or the platform 1102, the content services device(s) 1130, and the content delivery device(s) 1140 may be integrated, for example. In various embodiments, the platform 1102 and the display 1120 may be an integrated unit. The display 1120 and content service device(s) 1130 may be integrated, or the display 1120 and the content delivery device(s) 1140 may be integrated, for example. These examples are not meant to limit the embodiments.

In various embodiments, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

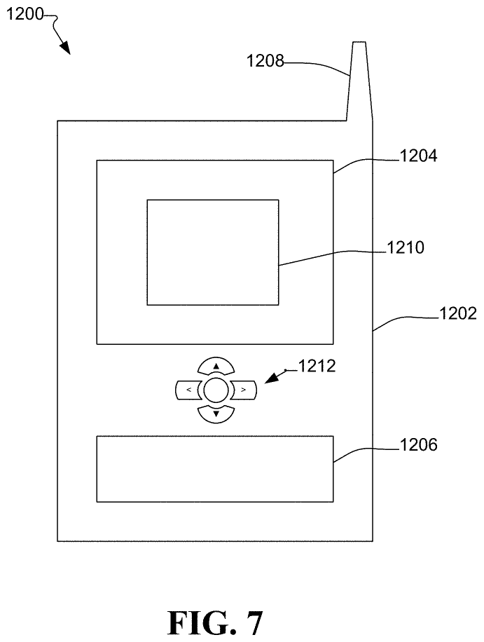

The platform 1102 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

As described above, the system 1100 may be embodied in varying physical styles or form factors. FIG. 7 illustrates embodiments of a small form factor device 1200 in which the system 1100 may be embodied. In embodiments, for example, the device 1200 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

Additionally, the system 1100 may further include a power source including a battery formed with one or more of the techniques described herein.

As shown in FIG. 7, the device 1200 may include a housing 1202, a display 1204, an input/output (I/O) device 1206, and an antenna 1208. The device 1200 also may include navigation features 1212. The display 1204 may include any suitable display unit for displaying information appropriate for a mobile computing device. The I/O device 1206 may include any suitable I/O device for entering information into a mobile computing device. Examples for the I/O device 1206 may include an alphanumeric keyboard, a numeric keypad, a touch pad, input keys, buttons, switches, rocker switches, microphones, speakers, voice recognition device and software, and so forth. Information also may be entered into the device 1200 by way of microphone. Such information may be digitized by a voice recognition device. The embodiments are not limited in this context.

Additionally, the device 1200 may further include a power source including a battery formed with one or more of the techniques described herein.

### Additional Notes and Examples

Example 1 may comprise a battery comprising: an electrode current collector; and an electrode compound layer that coats the electrode current collector. The electrode compound layer comprises a plurality of active material particles covered with a coating shell, wherein the coating shell comprises one or more transition metal chalcogenides.

Example 2 comprises the battery of Example 1, wherein the one or more transition metal chalcogenides comprise one or more transition metal sulfides.

Example 3 comprises the battery of any one of Examples 1 to 2, wherein the one or more transition metal chalcogenides comprise a component that is MoS2, TiS2, TaS2, WS2, MoSe2, WSe2, or a combination thereof.

Example 4 comprises the battery of any one of Examples 1 to 3, wherein the coating shell has one or more layers, wherein at least one layer of the one or more layers has a property that is a recoverable tensile strain no less than 10% when measured without an additive or without a reinforcement, a lithium ion conductivity no less than 10\hat{ }(−5) Siemens per centimeter at room temperature, a thickness from 0.5 nm to 100 μm, or a combination thereof.

Example 5 comprises the battery of any one of Examples 1 to 4, wherein the coating shell has a plurality of layers, wherein the plurality of layers comprises a first layer and a second layer, wherein the first layer is interposed between the second layer and an individual particle of the plurality of active material particles, wherein the first layer is of a different material composition than the second layer, and wherein the first layer has a more sulfur-rich material composition as compared to the second layer.

Example 6 comprises the battery of any one of Examples 1 to 5, wherein the plurality of active material particles comprises a material that is silicon, silicon oxide, lithium metal, lithium oxide, sulfur, sulfur oxide, tin, tin oxide, carbon, or a combination thereof.

Example 7 comprises the battery of any one of Examples 1 to 6, wherein the plurality of active material particles comprises a particle that is a spherical nano particle, an ellipsoidal nano particle, an irregular shape nano particle, a nano wire, a nano fiber, a nano tube, a nano sheet, a nano belt, a nano ribbon, a nano disc, a nano platelet, a nano strip, a nano horn, or combinations thereof having a thickness from 10 nanometers to 100 nanometers.

Example 8 comprises the battery of any one of Examples 1 to 7, wherein the plurality of active material particles comprises a silicon-based material powder with an average particle size between 10 nanometers and 10,000 nanometers.

Example 9 comprises the battery of any one of Examples 1 to 8, wherein the electrode conductor comprises an anode current collector and wherein the electrode compound layer coats the anode current collector.

Example 10 comprises the battery of any one of Examples 1 to 9 wherein the electrode conductor comprises a cathode current collector and wherein the electrode compound layer coats the cathode current collector.

Example 11 comprises the battery of any one of Examples 1 to 10, wherein the battery is a rechargeable lithium battery.

Example 12 comprises a system comprising: a processor and a battery coupled with the processor. The battery comprises: an electrode current collector and an electrode compound layer. The electrode compound layer coats the electrode current collector, wherein the electrode compound layer comprises a plurality of active material particles covered with a coating shell, wherein the coating shell comprises one or more transition metal chalcogenides.

Example 13 comprises the system of Example 12, wherein the one or more transition metal chalcogenides comprise one or more transition metal sulfides.

Example 14 comprises the battery of any one of Examples 12 to 13, wherein the one or more transition metal chalcogenides comprise a component that is MoS2, TiS2, TaS2, WS2, MoSe2, WSe2, or a combination thereof.

Example 15 comprises the battery of any one of Examples 12 to 14, wherein the coating shell has one or more layers, wherein at least one layer of the one or more layers has a property that is a recoverable tensile strain no less than 10% when measured without an additive or without a reinforcement, a lithium ion conductivity no less than 10\hat{ }(−5) Siemens per centimeter at room temperature, a thickness from 0.5 nm to 100 μm, or a combination thereof.

Example 16 comprises the battery of any one of Examples 12 to 15, wherein the coating shell has a plurality of layers, wherein the plurality of layers comprises a first layer and a second layer, wherein the first layer is interposed between the second layer and an individual particle of the plurality of active material particles, wherein the first layer is of a different material composition than the second layer, and wherein the first layer has a more sulfur-rich material composition as compared to the second layer.

Example 17 comprises the battery of any one of Examples 12 to 16, wherein the plurality of active material particles comprises a material that is silicon, silicon oxide, lithium metal, lithium oxide, sulfur, sulfur oxide, tin, tin oxide, carbon, or a combination thereof.

Example 18 comprises the battery of any one of Examples 12 to 17, wherein the plurality of active material particles comprises a particle that is a spherical nano particle, an ellipsoidal nano particle, an irregular shape nano particle, a nano wire, a nano fiber, a nano tube, a nano sheet, a nano belt, a nano ribbon, a nano disc, a nano platelet, a nano strip, a nano horn, or combinations thereof having a thickness from 10 nanometers to 100 nanometers.

Example 19 comprises a method, comprising: covering a plurality of active material particles with a coating shell, wherein the coating shell comprises one or more transition metal chalcogenides; and coating an electrode current collector with the electrode compound layer, wherein the electrode compound layer comprises the plurality of active material particles covered with the coating shell.

Example 20 comprises the method of Example 19, wherein the one or more transition metal chalcogenides comprise a component that is MoS2, TiS2, TaS2, WS2, MoSe2, WSe2, or a combination thereof.

Example 21 comprises an apparatus comprising means for performing the method of any one of Examples 19 to 20.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually include one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A battery comprising:
an electrode current collector; and
an electrode compound layer that coats the electrode current collector, wherein the electrode compound layer comprises a plurality of active material particles covered with a coating shell, wherein the coating shell comprises one or more transition metal chalcogenides.

2. The battery of claim 1, wherein the one or more transition metal chalcogenides comprise one or more transition metal sulfides.

3. The battery of claim 1, wherein the one or more transition metal chalcogenides include a component that is MoS₂, TiS₂, TaS₂, WS₂, MoSe₂, WSe₂, or a combination thereof.

4. The battery of claim 1, wherein the coating shell has one or more layers, wherein at least one layer of the one or more layers has a property that is a recoverable tensile strain no less than 10% when measured without an additive or without a reinforcement, a lithium ion conductivity no less than 10\hat{ }(−5) Siemens per centimeter at room temperature, a thickness from 0.5 nm to 100 μm, or a combination thereof.

5. The battery of claim 1, wherein the coating shell has a plurality of layers, wherein the plurality of layers includes a first layer and a second layer, wherein the first layer is interposed between the second layer and an individual particle of the plurality of active material particles, wherein the first layer is of a different material composition than the second layer, and wherein the first layer has a more sulfur-rich material composition as compared to the second layer.

6. The battery of claim 1, wherein the plurality of active material particles includes a material that is silicon, silicon oxide, lithium metal, lithium oxide, sulfur, sulfur oxide, tin, tin oxide, carbon, or a combination thereof.

7. The battery of claim 1, wherein the plurality of active material particles includes a particle that is a spherical nano particle, an ellipsoidal nano particle, an irregular shape nano particle, a nano wire, a nano fiber, a nano tube, a nano sheet, a nano belt, a nano ribbon, a nano disc, a nano platelet, a nano strip, a nano horn, or combinations thereof having a thickness from 1 nanometer to 100 nanometers.

8. The battery of claim 1, wherein the plurality of active material particles comprises a silicon-based material powder with an average particle size between 10 nanometers and 10,000 nanometers.

9. The battery of claim 1, wherein the electrode conductor comprises an anode current collector and wherein the electrode compound layer coats the anode current collector.

10. The battery of claim 1, wherein the electrode conductor comprises a cathode current collector and wherein the electrode compound layer coats the cathode current collector.

11. The battery of claim 1, wherein the battery is a rechargeable lithium battery.

12. A system comprising:
a processor; and
a battery coupled with the processor, wherein the battery comprises:
an electrode current collector; and
an electrode compound layer that coats the electrode current collector, wherein the electrode compound layer comprises a plurality of active material particles covered with a coating shell, wherein the coating shell comprises one or more transition metal chalcogenides.

13. The system of claim 12, wherein the one or more transition metal chalcogenides comprise one or more transition metal sulfides.

14. The system of claim 12, wherein the one or more transition metal chalcogenides include a component that is MoS₂, TiS₂, TaS₂, WS₂, MoSe₂, WSe₂, or a combination thereof.

15. The system of claim 12, wherein the coating shell has one or more layers, wherein at least one layer of the one or more layers has a property that is a recoverable tensile strain no less than 10% when measured without an additive or without a reinforcement, a lithium ion conductivity no less than 10\hat{ }(−5) Siemens per centimeter at room temperature, a thickness from 0.5 nm to 100 μm, or a combination thereof.

16. The system of claim 12, wherein the coating shell has a plurality of layers, wherein the plurality of layers includes a first layer and a second layer, wherein the first layer is interposed between the second layer and an individual particle of the plurality of active material particles, wherein the first layer is of a different material composition than the second layer, and wherein the first layer has a more sulfur-rich material composition as compared to the second layer.

17. The system of claim 12, wherein the plurality of active material particles includes a material that is silicon, silicon oxide, lithium metal, lithium oxide, sulfur, sulfur oxide, tin, tin oxide, carbon, or a combination thereof.

18. The system of claim 12, wherein the plurality of active material particles includes a particle that is a spherical nano particle, an ellipsoidal nano particle, an irregular shape nano particle, a nano wire, a nano fiber, a nano tube, a nano sheet, a nano belt, a nano ribbon, a nano disc, a nano platelet, a nano strip, a nano horn, or combinations thereof having a thickness from 1 nanometer to 100 nanometers.

19. A method, comprising:
covering a plurality of active material particles with a coating shell, wherein the coating shell comprises one or more transition metal chalcogenides; and
coating an electrode current collector with an electrode compound layer, wherein the electrode compound layer comprises the plurality of active material particles covered with the coating shell.

20. The method of claim 19, wherein the one or more transition metal chalcogenides include a component that is MoS₂, TiS₂, TaS₂, WS₂, MoSe₂, WSe₂, or a combination thereof.
